(19) United States
(12) Patent Application Publication
(10) Pub. No.: US 2012/0191427 A1
(43) Pub. Date: Jul. 26, 2012

(54) SYSTEM FOR DIAGNOSING ERROR CONDITIONS OF A GAS FLOW CONTROL SYSTEM FOR TURBOCHARGED ENGINES

(75) Inventors: Francesco CIANFLONE, Torino (IT); Gerhard LANDSMANN, Roedern (DE); Andreas SIDOROW, Darmstadt (DE); Christopher ECK, Darmstadt (DE); Rolf ISERMANN, Darmstadt (DE); Ulrich KONIGORSKI, Darmstadt (DE)

(73) Assignee: GM GLOBAL TECHNOLOGY OPERATIONS LLC, Detroit, MI (US)

(21) Appl. No.: 13/237,007

(22) Filed: Sep. 20, 2011

(30) Foreign Application Priority Data
Sep. 20, 2010 (GB) 1017266.6

(51) Int. Cl. G06F 17/10

(52) U.S. Cl. 703/2

(57) ABSTRACT

An evaluation unit is provided that includes, but is not limited to a microprocessor for receiving measurement signals from a gas flow control system of a combustion engine and for outputting a state signal indicating a state of the gas flow control system. A first set of measurement signals includes, but is not limited to a signal of a pressure upstream of a turbocharger and a signal of a pressure downstream of a turbocharger. A second set of measurement signal includes, but is not limited to a motor revolution speed. The microprocessor calculates first predicted values using a turbocharger model based on the first set of measurement signals and calculate a second predicted values using a nominal model based on the second set of measurement signals. The microprocessor further generates the state signal with a comparison of the first predicted values with the second predicted values.

### CROSS-REFERENCE TO RELATED APPLICATION

This application claims priority to British Patent Application No. 1017266.6, filed Sep. 20, 2010, which is incorporated herein by reference in its entirety.

### TECHNICAL FIELD

The technical field generally relates to diagnostics, and more particularly to systems for diagnosing error conditions of a gas flow control system for turbocharged engines.

### BACKGROUND

Since the 1990s, the common rail system or storage injection system has been introduced for diesel engines of passenger cars. The use of a common rail injection is, however, not limited to passenger cars, but it also includes heavy duty diesel engines, for example ship engines. A common rail injection uses common high pressure storage with corresponding outlets to supply the cylinders with fuel. The common rail injection optimizes the combustion process and the engine run and reduces the emission of particles. Due to the very high pressure of up to 2000 bar, the fuel is atomized very finely. Since small fuel drops have a high surface area, the combustion process is accelerated and the particle size of emission particles is decreased. Moreover, the separation of the pressure generation and the injection process allows for an injection process that is electronically controlled by using characteristic maps in a control unit, such as an engine control unit (ECU). The ECU may also be used to monitor the functionality of air handling control mechanisms for faults or failures that may occur during operation thereof. Error detection has been made mandatory in US and EU on-board diagnosis requirements.

The common rail injection system may be combined with a turbocharger to provide more driving comfort, especially for diesel engines in passenger cars. However, when combustion occurs in an environment with excess oxygen, peak combustion temperatures increase which leads to the formation of unwanted emissions, such as oxides of nitrogen (NOx). These emissions increase when a turbocharger is used to increase the mass of fresh air flow, and hence increase the concentrations of oxygen and nitrogen in the combustion chamber when temperatures are high during or after the combustion event.

One known technique for reducing unwanted emissions like NOx involves introducing chemically inert gases into the fresh air flow stream for subsequent combustion. Thereby, the oxygen concentration in the combustion mixture is reduced, the fuel burns slower and peak combustion temperatures are accordingly reduced and the production of NOx is reduced. One way of introducing chemically inert gases is through the use of a so-called Exhaust Gas Recirculation (EGR) system. EGR operation is typically not required under all engine operating conditions, and known EGR systems accordingly include a valve, commonly referred to as an EGR valve, for controlled introduction of exhaust gas to the intake manifold. Through the use of an on-board microprocessor, control of the EGR valve is typically accomplished as a function of information supplied by a number of engine operational sensors.

In addition to an EGR valve, air handling systems for modern turbocharged internal combustion engines are known to include one or more supplemental or alternate air handling control mechanisms for modifying the swallowing capacity and/or efficiency of the turbocharger. For example, the air handling system may include a wastegate disposed between an inlet and outlet of the turbocharger turbine to selectively route exhaust gas around the turbine and thereby control the swallowing capacity of the turbocharger. Alternatively or additionally, the system may comprise an exhaust throttle disposed in line with the exhaust conduit either upstream or downstream of the turbocharger turbine to control the effective flow area of the exhaust is throttle and thereby the efficiency of the turbocharger.

The turbocharger may also comprise a variable geometry turbine, which is used to control the swallowing capacity of the turbocharger by controlling the geometry of the turbine. By using variable nozzle ring geometry, the turbocharger operating envelope and performance can be changed during operation to optimize the engine performance for certain conditions. This type of turbochargers is useful e.g. in lean burn gas engines, where combustion is sensitive to gas quality and air temperature variations. VTG technology can also be used for heavy diesel engines, such as train and ship engines. However, the operating conditions of a turbocharger on a heavy fuel engine are rather demanding and VTG technology is, at least today, not commonly used for heavy fuel engines.

It is at least one object to provide an improved fault diagnostic for a gas flow control system of a turbocharged engine for a passenger car, especially of a common rail turbo diesel engine. In addition, other objects, desirable features and characteristics will become apparent from the subsequent summary and detailed description, and the appended claims, taken in conjunction with the accompanying drawings and this background.

### SUMMARY

A combustion engine evaluation unit is provided that comprises a microprocessor for receiving measurement signals from a gas flow control system of a combustion engine and for outputting a state signal that indicates a state of the gas flow control system. The microprocessor comprises input ports for receiving a first set of measurement signals, which comprise at least a pressure upstream of a turbocharger and a pressure downstream of a turbocharger.

Further input ports of the microprocessor are provided for receiving a second set of measurement signals that comprises at least a motor revolution speed. Advantageously, the second set of measurement signals also comprises a further measurement signal that allows to estimate the load on the engine, for example an output torque, a throughput of fuel, an actuator signal from a gas pedal or the like. Alternatively, the second set of measurement signals may also comprise an actuator signal for adjusting variable turbine geometry and an actuator signal for an exhaust gas recycling valve. The second set of measurement signals allows the microprocessor to predict the operation of the turbocharger under normal conditions, which is in the absence of failures. The first and second set of measurement signals may also be derived from the output of models that are based on measurement signals.

The microprocessor is adapted to calculate a first set of predicted values by using a turbocharger model, based on the first set of measurement signals and to calculate a second set of predicted values. The second set of predicted values is generated from a nominal model that is based on the second set of measurement signals. Furthermore, the microprocessor is adapted to generate the state signal based on a comparison of the first set of predicted values with the second set of predicted values.

Advantageously, the first set of predicted values is generated by a general model of the turbocharger, which is capable of predicting the first set of predicted values under fault conditions, whereas the second set of predicted values is generated by a nominal model of the turbocharger which models the normal operation of the turbocharger. The comparison of two sets of predicted values from the respective output of two independent models allows for a choice of predicted values that is more useful for the efficient prediction of fault conditions than directly measurable quantities only, for example the choice of energy conversion rates.

According to an embodiment, the comparison of the predicted values is based on forming differences of predicted values which each correspond to a physical quantity and on evaluating those differences. The differences are also referred to as “residuals”. For greater accuracy, in one embodiment, the evaluation of the residuals is performed depending on a partitioning of the parameter range of input parameters of the nominal model.

To further enhance the modeling accuracy, the two sets of measurement signals may comprise further signals. The microprocessor may comprise further input ports for receiving an actual turbocharger shaft speed, from which the state signal is generated by further including a comparison of a predicted turbocharger shaft speed with the actual shaft speed.

The first set of measurement signals may furthermore comprise a pressure signal that corresponds to a pressure downstream of a compressor of the turbocharger and a pressure signal that corresponds to a pressure between the compressor of the turbocharger and an exhaust turbine of the turbocharger. For more accurate modeling, the first set of measurement signals may also comprise a temperature signal that corresponds to a temperature upstream of the compressor of the turbocharger and a temperature signal that corresponds to a temperature between the compressor of the turbocharger and the exhaust turbine of the turbocharger. The second set of measurement signals may further comprise a measurement signal from which a brake mean effective pressure of the combustion engine can be derived.

According to another embodiment, a combustion engine evaluation unit is provided with the turbocharger model comprising a compressor model, a shaft model and an exhaust turbine model. Advantageously, the compressor model, the shaft model and the exhaust turbine model are adapted to generate predicted energy conversion rates at the compressor, the shaft and the exhaust turbine. It is advantageous to use energy conversion rates as predicted values. For example, conservation of energy can be used for a simple check of the predicted values for consistency. The shaft model may furthermore be adapted to generate a predicted shaft speed.

In a further embodiment, the compressor model is furthermore adapted to generate a predicted compressor mass flow and a temperature downstream of the compressor of the turbocharger and the exhaust turbine model is furthermore adapted to generate a turbine mass flow and a temperature downstream of the exhaust turbine of the turbocharger. The additional predicted values allow for a more accurate identification of fault conditions.

The comparison of the first set of predicted values with the second set of predicted values may be provided by at least one differentiator which is technically easy to realize. Advantageously, one differentiator is provided for each predicted value of the nominal model. The use of differentiators instead of more complicated units is an advantage of the present application. However, the comparison of predicted values may also be provided by at least one correlator that provides a statistical correlation.

The nominal model may be provided by a nominal model unit that comprises an interpolation unit. More specifically, the interpolation unit may be provided by a realization of a semi-physical model, a neuronal network, and a locally linear model tree (LOLIMOT) or other empirical model. Specifically, the interpolations may be based on values of a look up table which is precomputed based on the aforementioned models during a calibration procedure.

Furthermore, an engine control unit is provided that comprises the aforementioned combustion engine evaluation unit, a combustion engine that comprises a turbocharger, a gas flow control system and the aforementioned engine control unit, a powertrain with the aforementioned combustion engine and a vehicle with the aforementioned powertrain.

A gas flow control system provides a reliable identification of faulty components. The indication of faulty parts according to the application helps to avoid pollution and safety hazards that result from driving with faulty components and extends the lifetime of mechanical parts through timely exchange of the faulty components. Furthermore, a gas flow control system according to the application assists the service personnel in quickly identifying the cause of a malfunction. Apart from identifying error conditions, the gas flow control system can also be used to adjust the engine control, such as the control of the fuel injection or of the valve openings, in order to maintain the function even in the case of degrading performance of mechanical parts.

### BRIEF DESCRIPTION OF THE DRAWINGS

The present invention will hereinafter be described in conjunction with the following drawing figures, wherein like numerals denote like elements, and:

FIG. 1 shows a diagrammatic illustration of a gas flow control system for a turbo diesel engine;

FIG. 2 illustrates a turbocharger modeling unit:

FIG. 3 illustrates a residual generating unit with a nominal turbocharger modeling unit;

FIG. 4 illustrates a further embodiment of a residual generating unit;

FIG. 5 illustrates a decision logic and an error display for evaluating the residuals;

FIG. 6 illustrates a neural network of a further embodiment of a decision logic;

FIG. 7 illustrates an embodiment of an evaluation unit;

FIG. 8 illustrates a further embodiment of an evaluation unit;

FIG. 9 illustrates an engine speeds and a motor torque diagram;

FIG. 10 illustrates a diagram of a nominal model for a shaft speed;

FIG. 11 illustrates a flow diagram of a residual evaluation;

FIG. 12 shows a partitioning of a parameter space; and

FIG. 13 illustrates a definition procedure for lower and upper thresholds of residuals.

### DETAILED DESCRIPTION

The following detailed description is merely exemplary in nature and is not intended to application and uses. Furthermore, there is no intention to be bound by any theory presented in the preceding background or summary or the following detailed description. In the following description, details are provided to describe the embodiments of the application (invention). It shall be apparent to one skilled in the art, however, that the embodiments may be practiced without such details.

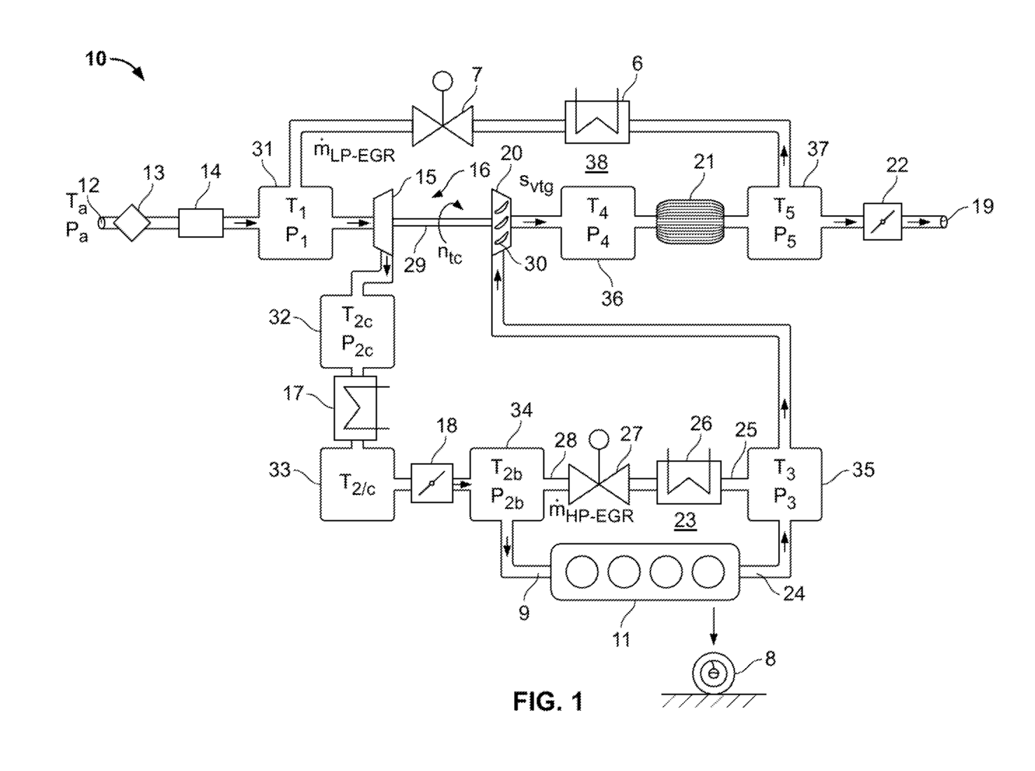

FIG. 1 shows a diagrammatic illustration of a gas flow control system 10 for a turbo diesel engine 11. A crankshaft of the diesel engine 11 is connected a drivetrain which is connected to wheels 8 of a car. For simplicity, crankshaft and drivetrain are not shown in FIG. 1. Between an air intake 12 and an air inlet 9 of the diesel engine 11, the gas flow control system 10 comprises an air filter 13, a hot film (HFM) air mass flow sensor 14, a compressor 15 of a turbocharger 16; an intake air cooler 17 and an intake air throttle 18. Between the diesel engine 11 and an exhaust outlet 19, the gas flow control system 10 comprises an exhaust turbine 20 of the turbocharger 16; a diesel particulate filter (DPF) 21 and an exhaust throttle 22.

The gas flow control system 10 comprises a high pressure exhaust gas recirculation (HP EGR) circuit 23. Between an exhaust outlet 24 of the diesel engine 11 and the air intake 9 of the diesel engine 11, the HP-EGR circuit 23 comprises a bypass branch 25, a HP-EGR cooler 26, a HP-EGR valve 27 and a recirculation branch 28. Furthermore, a low pressure exhaust gas recirculation (LP-EGR) circuit 38 is provided between the DPF 21 and the compressor 15. The LP-EGR circuit 38 comprises an LP-EGR cooler 6 and an LP-EGR valve 7 downstream of the LP-EGR cooler 6.

For simplicity, pipes from and to the cylinders of the diesel engine 11 are not indicated separately. Likewise, fuel lines are not shown. The exhaust turbine 20 and the compressor 15 are linked by a compressor shaft 29 and the rotation velocity n_tc of the compressor shaft 29 is indicated by a circular arrow. The exhaust turbine has a variable geometry which is controlled by a control signal sVTG. The variable geometry of the exhaust turbine 20 is realized by adjustable turbine blades 30 which are indicated by slanted lines. Mass flow rates of the HP-EGR circuit 23 and the LP-EGR cycle are indicated by corresponding symbols and the ambient input temperature and pressure upstream of the air filter 13 are indicated by symbols T_a and p_a.

Various locations of sensors in the gas flow are indicated by square symbols. The square symbol is only symbolic and does not indicate the precise shape of a gas pipe at the location of a sensor. A first sensor location 31 and corresponding temperature T_1 and pressure p_1 are indicated between the HFM air mass flow sensor 14 and the compressor 15; a second sensor location 32 and corresponding temperature T_2c and pressure p_2c are indicated between the compressor 15 and the intake air cooler 17; a third sensor location 33 and corresponding temperature T_2ic is indicated between the intake air cooler 17 and the intake air throttle 18; a fourth sensor location 34 and corresponding temperature T_2i and pressure p_2i are indicated between the intake air throttle 18 and the air inlet 9 of the diesel engine 11 or, respectively, the HP-EGR valve 27; a fifth sensor location 35 and corresponding temperature T_3 and pressure p_3 are indicated between the outlet 24 of the diesel engine 11 and the HP-EGR cooler 26 or, respectively, the exhaust turbine 20; a sixth sensor location 36 and corresponding temperature T_4 and pressure p_4 are indicated between the exhaust turbine 20 and the DPF 21; a seventh sensor location 37 with corresponding temperature T_5 and pressure p_5 is indicated between the DPF 21 and the exhaust gas throttle 22. Downstream of the exhaust gas throttle 22 there are an H₂S catalyst and an exhaust silencer which are not shown in FIG. 1. The gas flow control system 10 may be realized with our without the low pressure EGR cycle 38. Moreover, the HP-EGR circuit 23 may be provided separately for cylinders or groups of cylinders. A NOₓ storage catalyst (NSC) may be provided upstream of the exhaust gas throttle 22.

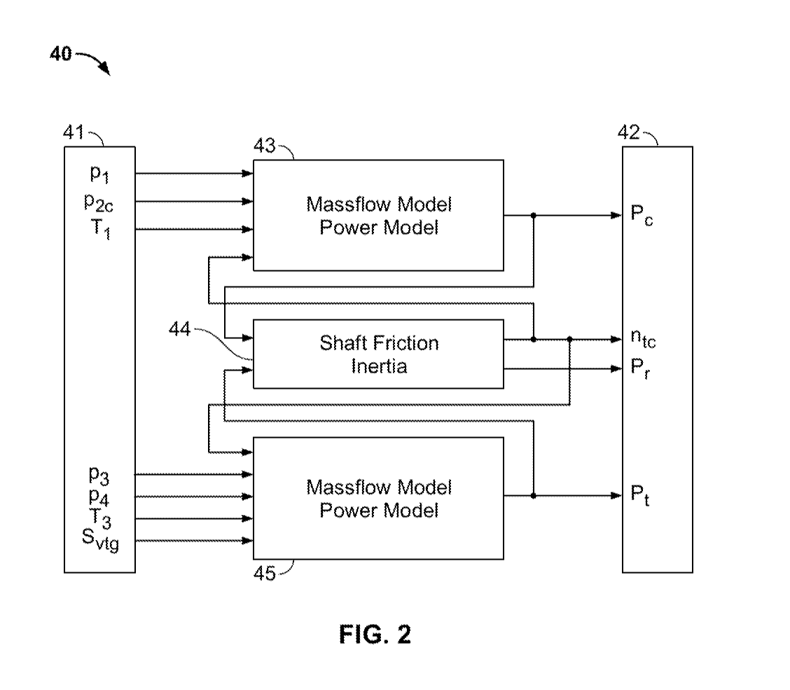

FIG. 2 shows a flow diagram of a turbine modeling unit 40 for calculating the four predicted values P_c, n_tc, P_r, P_t from the seven input values p_1, p_2c, T_1, p_3, p_4 T_3, s_vtg. An input interface 41 is provided for receiving the input values and an output interface 42 is provided for outputting the output values. The turbine modeling unit 40 comprises an air compressor modeling unit 43, a shaft transmission modeling unit 44 and an exhaust turbine modeling unit 45.

Input values of the air compressor unit comprise the pressure p_1 and the temperature T_1 at the location 31 between the air flow meter 14 and the compressor 15 and the pressure p_2c at the location 32 between the compressor 15 and the intake air cooler 17. Input values of the exhaust turbine modeling unit 45 comprise the pressure p_3 and the temperature T_3 at the location 35 between the outlet 24 and the exhaust turbine 20 and the pressure p_4 at the location 36 between the exhaust turbine 20 and the dpf 21, as well as the input value s_vtg, which represents a position of the turbine blades 30.

The compressor modeling unit 43 provides the predicted value P_c which represents a compressor output power. The exhaust turbine modeling unit 45 provides the output value P_t, which represents the turbine input power. Input values of the shaft transmission modeling unit 44 comprise the turbine input power P_t and the compressor output power P_c. The shaft transmission unit provides the predicted value n_tc, which represents the turbine shaft revolution speed, and the predicted value P_r which represents the power loss P_r due to the transmission. Herein, “power” is to be understood as energy per time. The output of the model calculations for a given input may be stored in precomputed lookup tables for faster access.

In a further development of the compressor modeling unit 43, the energy conversion rate P_C at the compressor 15 is computed on basis of the pressures p_1, p_2c the temperature T_1, an estimated mass flow rate and an estimated isentropic efficiency at the compressor. The estimated mass flow rate is computed by a mass flow rate submodel which is based on the pressures p_1, p_2c and the predicted value n_tc using a local linear modeling tree (LLM) approach. The estimated isentropic efficiency is computed by an isentropic efficiency sub-model, based on the estimated mass flow rate and the predicted value n_tc of the shaft speed using an LLM approach.

More specifically, the rate P_C is modeled according to the relation:

$${P}_{C} = {\dot{m}}_{C} {c}_{p , air} \frac{1}{{η}_{C}} {T}_{1}^{*} ( 1 - {( \frac{{p}_{2 c}}{{p}_{3}} )}^{\frac{{κ}_{air} - 1}{{κ}_{air}}} ) \qquad ( 1 )$$

where d/dt(m_c) is the compressor mass flow rate, c_P,air the constant pressure specific heat constant of the ambient air, η_C the aerodynamical efficiency, T_1* a corrected temperature and κ_air an adiabatic index of the ambient air.

The compressor mass flow, the aerodynamic efficiency and the corrected temperature are modeled according to the relations:

$${\dot{m}}_{C}^{*} = LLM ( \frac{{p}_{2 c}}{{p}_{1}} , {n}_{tc} )$$

$${η}_{C} = LLM ( {\dot{m}}_{C} , {n}_{tc} ) , \\ {T}_{1}^{*} = {T}_{1} - Δ {T}_{13} ,$$

Where LLM stands for LLM models, and ΔT_31 for a temperature difference which is in turn computed according to:

$$Δ {T}_{13} = \frac{{α}_{13}}{{c}_{p , air} {\dot{m}}_{C}} ( {T}_{3} - {T}_{1} ) .$$

Similar to the model calculations, the output of the submodel calculations for a given input may be stored in precomputed lookup tables for faster access. For higher accuracy, an effective temperature T_1* may be estimated from the temperature difference T_3−T_1 using a heat transfer submodel. The use of an LLM approach has the advantage of providing an approximate modeling of nonlinear relationships by using faster computable linear functions. Moreover, it simplifies an optimization procedure in which model parameters are adjusted. The LLM approach may even allow the online adjustment of parameters.

In a further development of the exhaust turbine modeling unit 45, the energy conversion rate P_T at the exhaust turbine 20 is computed on the basis of the pressures p_3, p_4, the temperature T_3, an estimated mass flow rate and an estimated aerodynamic efficiency at the exhaust turbine. The estimated aerodynamical efficiency is computed by an aerodynamic submodel based on a normalized blade speed and the turbine geometry control signal s_VTG using an LLM approach. In turn, the normalized blade speed is computed from the pressures p_3, p_4, the temperature T_3 and the predicted shaft speed n_tc. The estimated mass flow rate is computed by a mass flow submodel based on the pressures p_3, p_4, the temperature T_3 and an effective opening parameter. The effective opening parameter, in turn, is computed based on the turbine geometry control signal s_VGT and the predicted shaft speed n_tc using an LLM approach. For higher accuracy, an effective temperature T_3* may be estimated from the temperature difference T_3- and T_1 using a heat transfer submodel.

More specifically, the rate P_t is modeled by the relation:

$${P}_{t} = {\dot{m}}_{t} {c}_{P , e} {η}_{t , aero} {T}_{3}^{*} ( 1 - {( \frac{{p}_{4}}{{p}_{3}} )}^{\frac{{κ}_{exh} - 1}{{κ}_{exh}}} ) \qquad ( 2 )$$

Where d/dt(m_T) is the turbine mass flow rate, c_P,e the constant pressure specific heat constant of the exhaust gas, η_t,aero the aerodynamical efficiency, T_3* a corrected temperature and κ_exh an adiabatic index of the exhaust gas.

The aerodynamical efficiency, the mass flow and the corrected temperature are modeled according to the following three relations:

$${η}_{t , aero} = LLM ( {c}_{u} , {s}_{vtg} ) , \\ {\dot{m}}_{t}^{*} = μ {A}_{eff} \frac{{p}_{3}}{\sqrt{{RT}_{3}}} \sqrt{\frac{2 {κ}_{exh}}{{κ}_{exh} - 1} [ {( \frac{{p}_{4}}{{p}_{3}} )}^{\frac{2}{{κ}_{exh}}} - {( \frac{{p}_{4}}{{p}_{3}} )}^{\frac{{κ}_{exh} + 1}{{κ}_{exh}}} ]}$$

$${T}_{3}^{*} = {T}_{3} - Δ {T}_{31} ,$$

Where LLM stands for an LLM model, c_u is a normalized blade speed, μ a constant, A_eff an effective opening and ΔT_31 a temperature difference. In turn, the normalized blade speed, the effective opening and the temperature difference are modeled according to the relations:

$${c}_{u} = \frac{π D {n}_{tc}}{\sqrt{2 {c}_{p} {T}_{3}^{*} [ 1 - {( \frac{{p}_{3}}{{p}_{4}} )}^{\frac{{κ}_{exh} - 1}{{κ}_{exh}}} ]}} , \\ μ {A}_{eff} = LLM ( {s}_{vgt} , {n}_{tc} )$$

$$and$$

$$Δ {T}_{31} = \frac{{α}_{13}}{{c}_{p , exh} {\dot{m}}_{t}} ( {T}_{3} - {T}_{1} ) .$$

For an exact modeling, the power balance equation P_c=P_t−P_r would hold, but due to measurement, modeling and computation inaccuracies, a modeling error e_{power}=Pₜ−P_{c}−Pᵣ exists. Likewise, there is a modeling error e_{n,tc}=n_{tc,measured}−n_{tc,model} for the predicted shaft speed. During a calibration procedure according to the application, parameters of the turbine modeling unit are adjusted such that the modeling errors are minimized.

During operation of the diesel engine 11, the input values p_1, p_2c, T_1, p_3, p_4, T_3 are measured by sensors at the sensor locations 31, 32, 35 and 36 and are converted into electrical signals and transmitted to the input interface 41. Furthermore, the input value s_vtg of the turbine geometry is transmitted from a turbocharger control to the input interface 41. The compressor modeling unit 43 generates the output value P_c using a model to predict the mass flow and a model to predict the energy conversion rate of the compressor 15. The exhaust turbine modeling unit 45 generates the output value P_t using a model to predict the mass flow and a model to predict the energy conversion rate of the exhaust turbine 20. Using the output values P_c and P_t and a model for the shaft friction and the shaft inertia the shaft transmission modeling unit 44 generates the output values n_tc and P_r.

The input values of the turbocharger modeling unit 40 may also be derived from measured values by the use of further models. For example, the input values p_1, T_1 may be generated as outputs of an air filter model or as an output of an air filter and an LP-EGR circuit model, if an LP-EGR circuit is present. The airfilter takes the ambient pressure p_a and the ambient temperate T_a as input values. Secondly, p_2c may be obtained from an output of an intercooler and throttle pressure drop model that is based on the pressure p_2i. Thirdly, p_3, T_3 may be obtained from an output of an engine model that may in turn comprise a model for the HP-EGR circuit. The engine model uses p_2i, T_2i, q_Inj, n_eng as input values, wherein q is the amount rate of injected fuel. Fourthly, p_4 may be obtained from output values of DPF pressure drop model which may in turn comprise a model of an LP-EGR circuit.

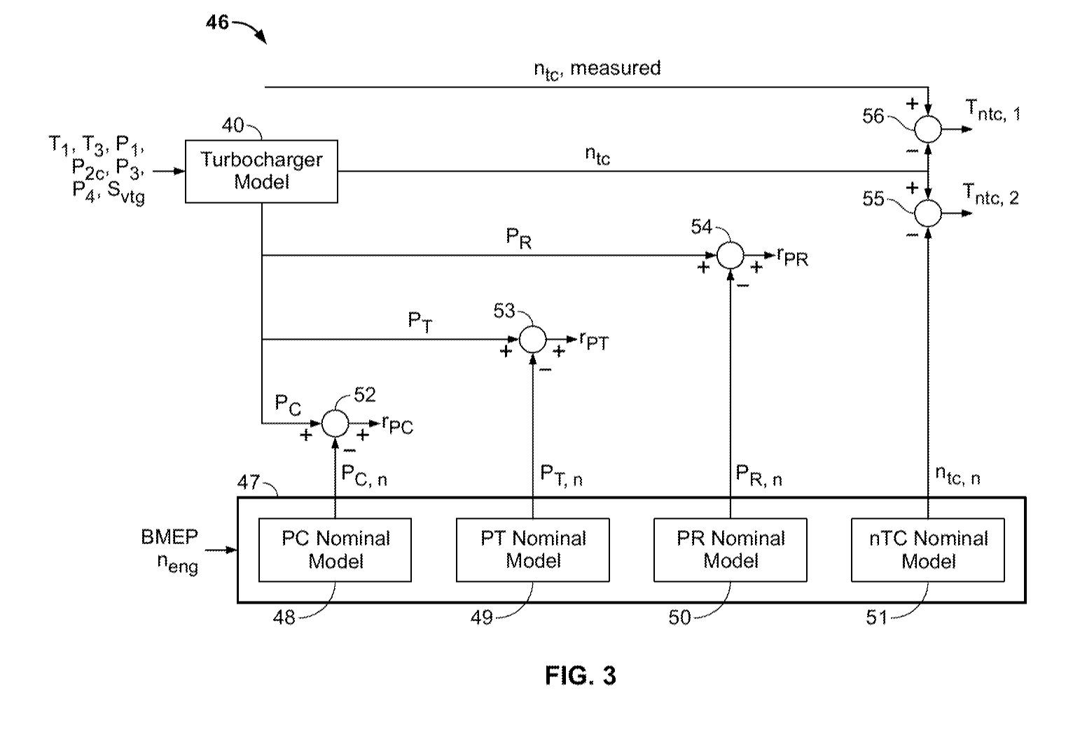

FIG. 3 shows a residual generating unit 46 which forms part of a fault detection unit for the gas flow control system 10. The residual generating unit 46 comprises the turbocharger modeling unit 40 of FIG. 2 and a nominal turbocharger modeling unit 47. The nominal turbocharger modeling unit 47 comprises a compressor power modeling unit 48, a turbine power modeling unit 49, a shaft transmission power modeling unit 50 and a shaft speed modeling unit 51. The modeling units 48, 49, 50, 51 predict the output values P_c,n, P_T,n, P_R,n and n_tc,n which correspond to the compressor power, the turbine power, the shaft transmission power and the shaft speed from the engine output speed n_eng and the brake mean effective pressure (BMEP) under normal operating conditions. Herein, normal operating condition refers to essentially fault free operation of mechanical parts of the gas flow control system 10.

The engine speed is measured by a rotation sensor at an output shaft of the engine and the ECU computes the BMEP from an averaged output torque of the engine output shaft as follows. The mean effective pressure p_mep of an internal combustion motor is given by the equation:

$${p}_{mep} = \frac{{Pn}_{c}}{{V}_{d} N} = \frac{2 π {Tn}_{c}}{{V}_{d}} \qquad ( 3 )$$

Where P is the power output, pₘₑₚ is the mean effective pressure, V_{d} is the displacement volume in n_{c} is the number of revolutions per cycle (for a 4-stroke engine n_{c}=2), N is the number of revolutions per second and T is the averaged output torque of the motor. From equation (1), the Brake Mean Effective Pressure or BMEP is calculated from a measured dynamometer torque T_dyn. Alternatively or in addition, an indicated mean effective pressure or IMEP may be calculated using the indicated power which is the pressure volume integral in the work per cycle equation.

The residual generating unit 46 comprises a differentiator 52, a differentiator 53, a differentiator 54, a differentiator 55 and a differentiator 56. The differentiators 52-56 may be realized for example as adders with inverters or by bit-operations. The differentiator 52 computes the difference of the predicted compressor powers P_c and P_cn to generate a compressor power residual r_PC. The differentiator 53 computes the difference of the predicted turbine powers P_T and P_T,n to generate a turbine power residual r_PT. The differentiator 54 computes the difference of the predicted shaft transmission powers P_R and P_R,n to generate a shaft power residual r_PR. The differentiator 56 computes a difference of a measured shaft speed n_tc, measured and the predicted shaft speed n_tc to generate a first shaft speed residual r_ntc,1. The differentiator 57 computes a difference of the predicted shaft speeds n_tc and n_tc,n to generate a second shaft speed residual.

An evaluation unit, which is not shown in FIG. 3, uses the five residuals r_PC, r_PT, r_PR, r_ntc,1 and r_ntc,1 as input to determine an error condition of the 10. In a simple implementation of the evaluation unit, an error condition is generated if at least one of the residuals is above a limit value and the specific error condition is determined from the combination of residuals that lie above respective limit values. To avoid a false alarm due to outliers of the residuals, the evaluation unit may further comprise implementations of averaging procedures and statistical evaluations for the residuals. The generated error condition is then converted into an error message that is further processed, for example by displaying a servicing message on a car dashboard.

The nominal model units 48, 49, 50, 51 comprises stored parameters which are calibrated during a calibration procedure, for example an engine test bench measurement, a measurement of output signals from excitations by corresponding input signals or, in the case of an artificial neural network (ANN) implementation, a partitioning of training and validation data. The parameters may be realized, for example, by weights of an ANN, or, more specifically, by weights of a local linear neural network, by coefficients of polynomials, splines or other basis functions or by parameters of semi-physical structured models. During calibration, the parameters of the nominal models of the nominal model units 48, 49, 50, 51 are optimized. The optimization of the model parameters is in general a nonlinear optimization problem for which deterministic methods like variable metric, conjugate gradient, and steepest descent but also stochastic methods like simulated annealing by Monte Carlo methods are available. In general it will be sufficient to find a local optimum of the model parameters which approximates a “true” global optimum. The term “optimization” also refers to such an approximate optimization.

According to one embodiment, the parameters of the model are evaluated at certain operating points of the motor. In one example, the operating points are prescribed by keeping the engine speed at levels of 1000, 1500, 200, 2500, 3000 and 3500 rpm during time intervals of 20 seconds and increasing the motor output torque in levels of 15.1, 30.2, 60.5, 90.7, 121.0 and 151.2 Nm during a time interval of 20 seconds. Combinations of input parameters that are less frequent or do not occur at all, such as the combination (1000 rpm, 151.2 Nm) may be left out.

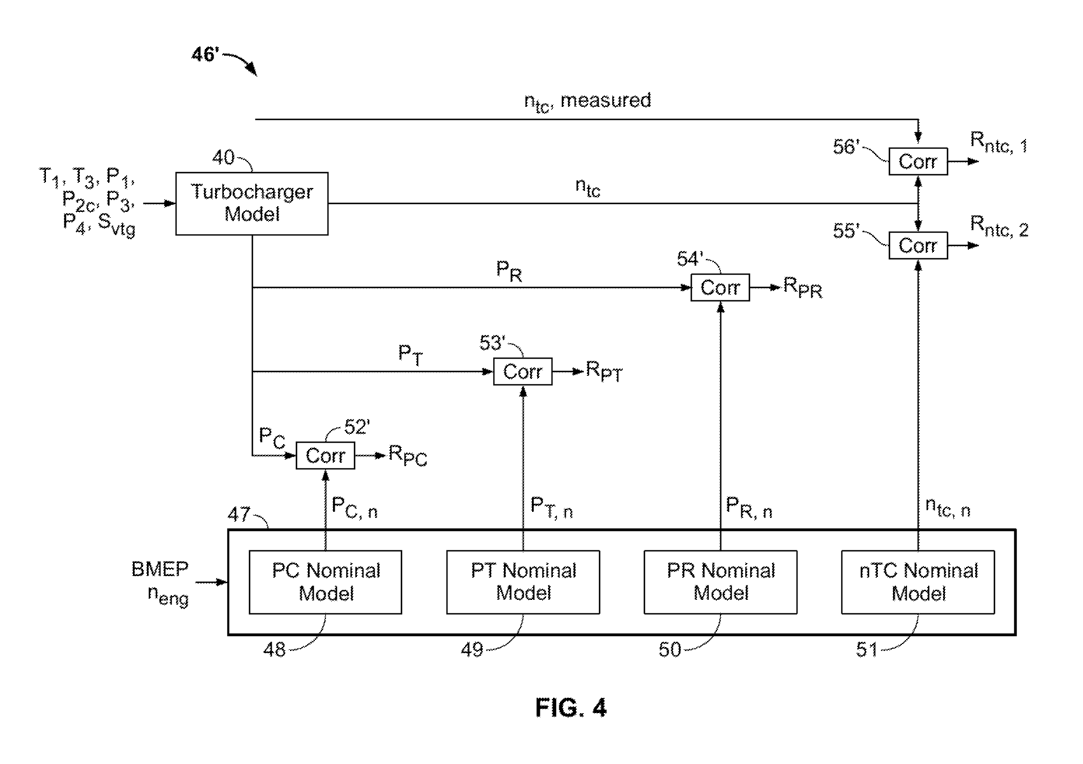

FIG. 4 shows a further embodiment of a residual generating unit 46′ in which, in place of the differentiators 52′, 53′, 54′, 55′, 56′ correlators are used. The correlators 52′, 53′, 54′, 55′, 56′ compute correlations of two input values. For example, the correlator 52′ computes the correlation R_PC from the input values P_C and P_C,n according to the formula

$${R}_{PC} = \frac{N}{N - 1} {\sum }_{k = 1}^{N} ( \frac{{P}_{C} ( k ) - {\overline{P}}_{C}}{σ {P}_{C}} ) ( \frac{{P}_{C , n} ( k ) - {\overline{P}}_{C , n}}{σ {P}_{c , n}} ) . \qquad ( 4 )$$

Herein, P̅_{C} and P̅_{C,n} stand for the mean or expectation values and σP_{C} and σP_{c,n} stand for the standard deviations, k is a time index and N the sample size.

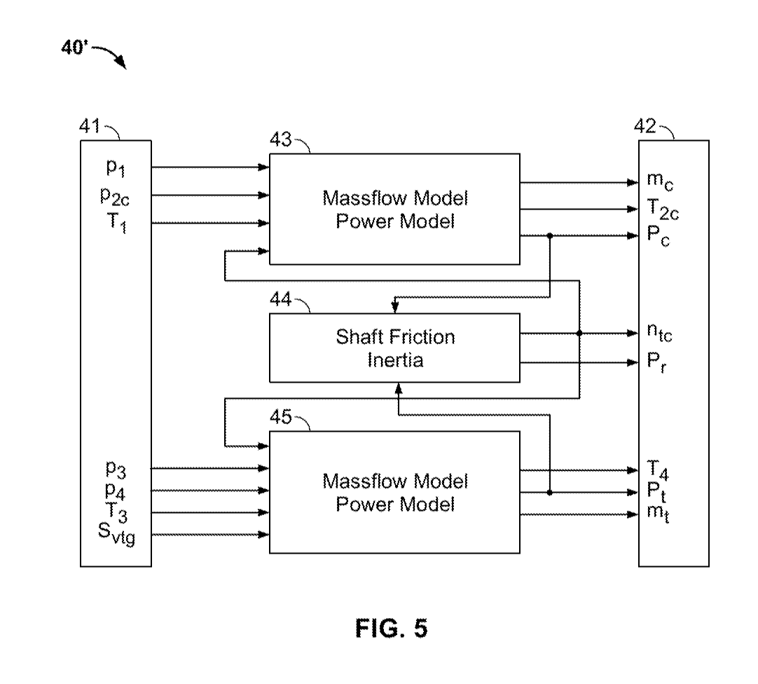

FIG. 5 shows a further embodiment of a turbocharger modeling unit. In addition to the output values shown in FIG. 2, the compressor modeling unit 43′ generates a predicted gas flow rate m_c and a predicted temperature T_2c as output values. Furthermore, the turbine modeling unit 45′ generates in addition a gas flow m_t and a temperature T_4 as output values. Furthermore, sensors for measuring the temperatures T_2c and T_4 can be used as input for or instead of the nominal models 77 and 78 for generating the corresponding residuals.

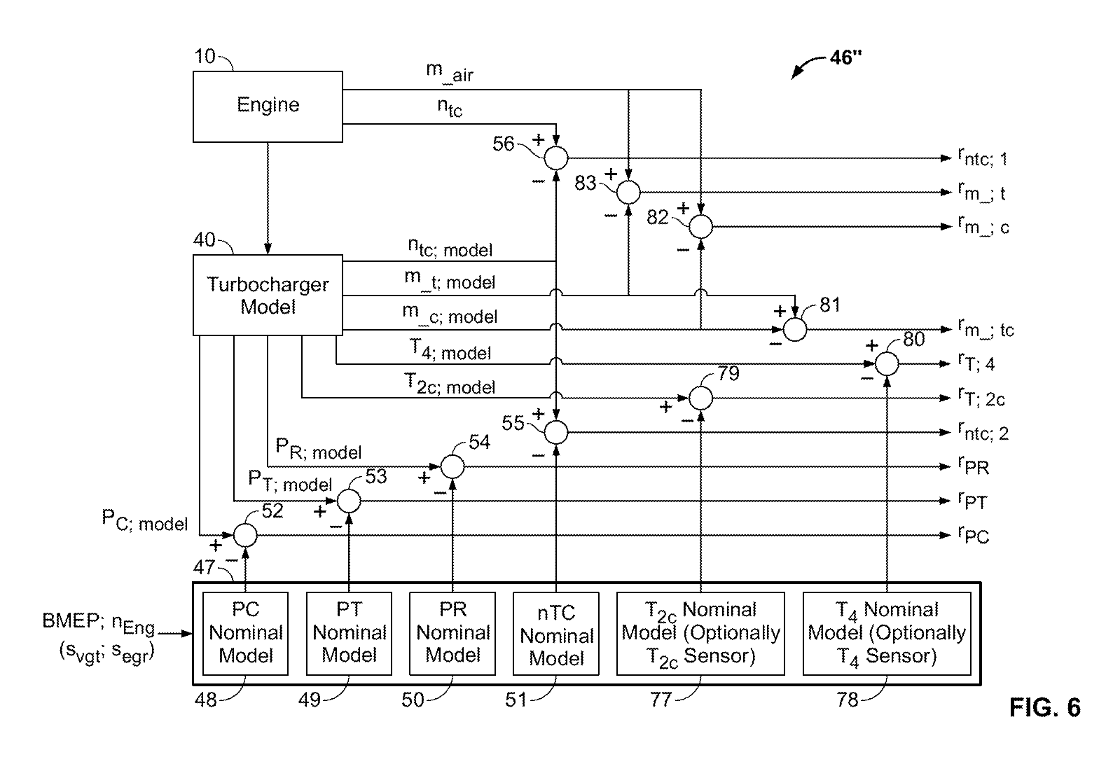

FIG. 6 shows a residual generating unit 46″ for generating residuals from the predicted values of FIG. 5. The residual generating unit comprises in addition a nominal model 77 for modeling the temperature T_2c and a nominal model 78 for modeling the temperature T_4, as well as differentiators 79, 80, 81, 82, 83 for generating residuals the four addition residuals. In the embodiment of FIG. 5, the mass flow rates are compared with output values of mass flow sensors. It is also shown in FIG. 6 that, alternatively to the BMEP and the engine speed, the actuator signal sVGT for the turbine geometry and an actuator signal s_egr for the valve opening of the HP-EGR valve 27 may be used as input signals for the nominal model. Furthermore, an actuator signal for the valve opening of a LP-EGR valve 7 may be used in addition, if a low pressure EGR cycle is present. As a further alternative, values of T2c and/or T4 at the differentiators 79, 80 may be taken from a sensor signal instead of using the nominal model units 77 and/or 78. In this case, the differentiators 79, 80 compute the residuals rT;2c from the difference T_2c, model−T2c, sensor and/or the residual rT;4 from the difference T4,model−T4, sensor.

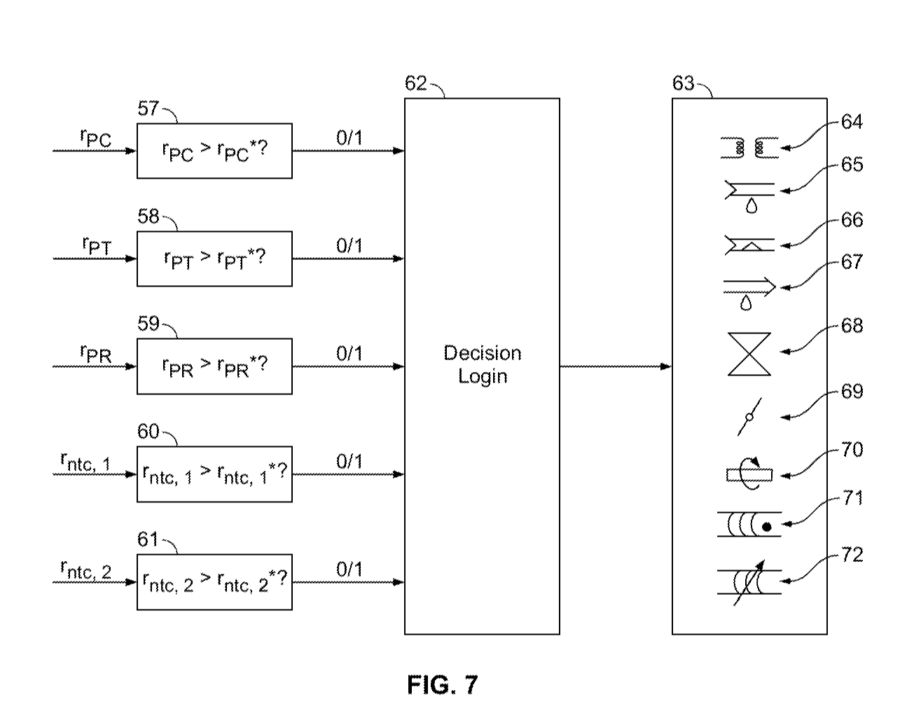

FIG. 7 shows an embodiment of an evaluation unit in which the evaluation unit comprises comparators 57, 58, 59, 60, 61 and a decision logic circuit 62. Outputs of the comparators are connected to inputs of the decision logic circuit 62. An output of the decision logic circuit 62 is connectable to a control display 63. The control display 63 provides display symbols 64, 65, 66, 67, 68, 69, 70, 71, 72 to indicate the error conditions of a blow-by pipe failure, an intake manifold leakage, an intake manifold blockage, an exhaust manifold leakage, an EGR-valve failure, a swirl flap failure respectively.

During operation, the comparators compare the absolute value of the residuals r_PC, r_PT, r_PR, r_ntc,1, r_ntc,2 against the corresponding limit values r_PC*, r_PT*, r_PR*, r_ntc,1*, r_ntc,2*, respectively and generate binary output signals. Alternatively, comparators are provided to compare the value of the residuals, which may be positive as well as negative, against respective negative and positive limiting values r_PC+, r_PC−, r_PT+, rPT−, r_PR+, r_PR−, r_ntc,1+, r_ntc,1−, r_ntc,2+, r_ntc,1−.

The binary output signals are evaluated by the decision logic circuit 62 and an error condition signal is generated. The error condition signal may indicate a single error condition or also a combination of error conditions. In a particularly simple embodiment, the logic circuit 62 comprises a lookup table for mapping the binary outputs of the comparators 57, 58, 59, 60, 61 to an error condition value that indicates an error condition or a combination of error conditions. On the control display 63, display symbols are displayed which correspond to the error condition value.

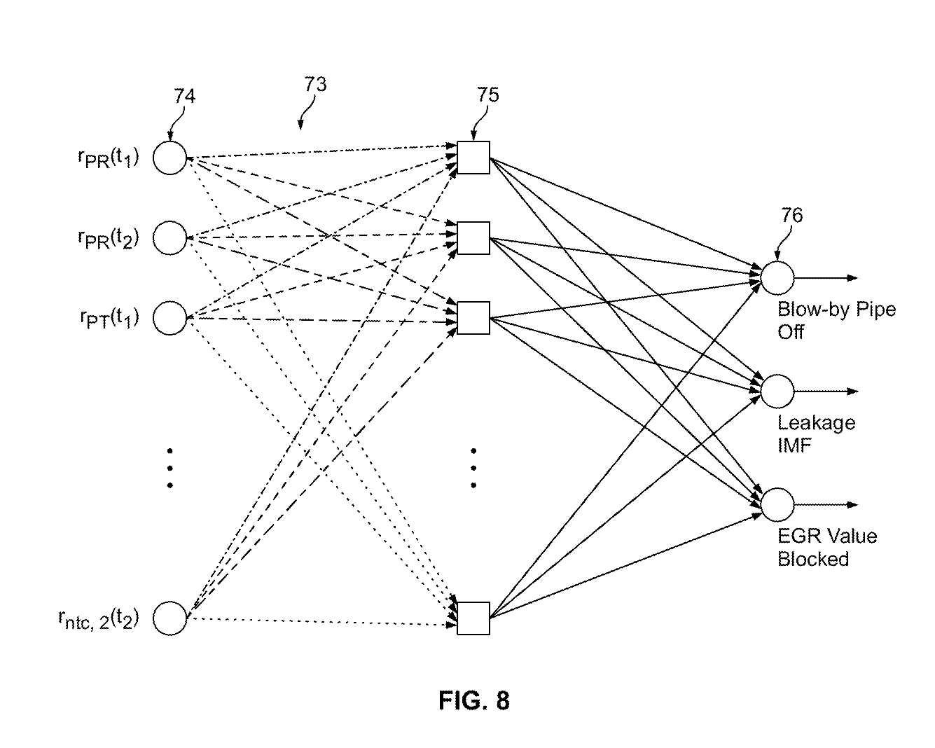

FIG. 8 shows a further embodiment of an evaluation unit in which the evaluation unit is designed as an ANN 73 of the multi-layer perceptron type. The ANN 73 comprises an input layer 74 of nodes, a processing layer 75 of nodes and an output layer 76 of nodes. Nodes which are not shown for simplicity in FIG. 8 are indicated by ellipsis dots. Residual values at two different sampling times t_1 and t_2 are provided to the nodes of the input layer 74. During operation of the ANN 73, the nodes of the processing layer 75 and the output layer 76 compute an output from a weighted average of their input values.

During a training of the ANN 73, values of residuals which are characteristic of certain error conditions are presented to the ANN 73 and weights of the weighted sums are adjusted such that the output values of the output layer nodes match the error condition. Here, by way of example, only the blow-by pipe, IMF leakage and EGR valve error conditions are shown. The ANN 73 may be extended to process residual values from more than just two sampling times or it may also process the current value of a residual only. Furthermore, the possible residual values may be portioned into intervals and the intervals may be assigned to different input nodes of the input layer 74. The ANN 73 may also comprise a further processing layer of nodes between the processing layer 75 and the output layer.

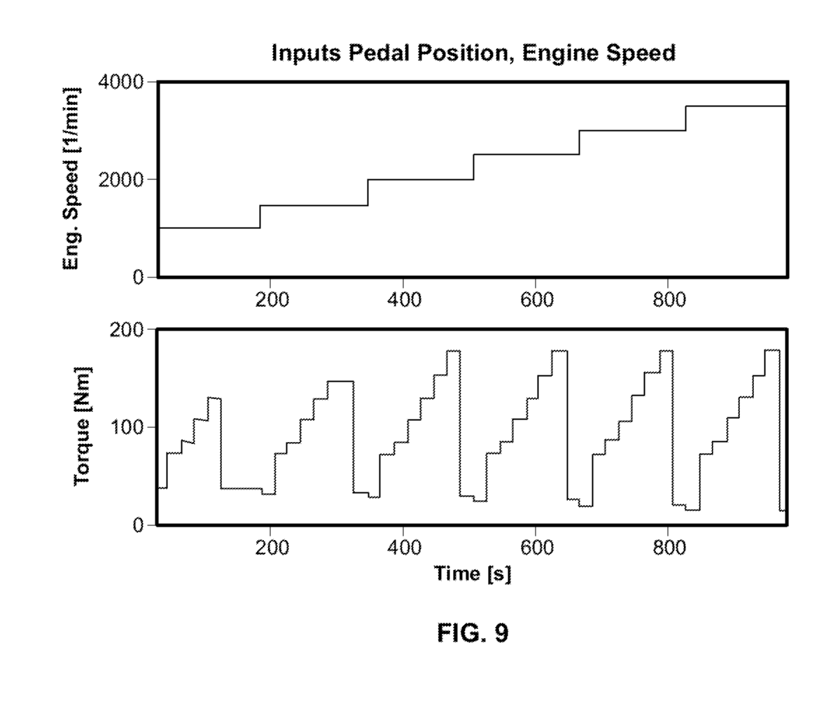

FIG. 9 illustrates two diagrams which show engine speeds and motor torques during a training run of the nominal model units shown in FIGS. 3 and 4. The engine speeds and motor torques define operating points. The operating points are indicated by a “+” sign in the following table:

| BMEP | Torque | Engine speed [rpm] | | | | | |
|---|---|---|---|---|---|---|---|
| [bar] | [Nm] | 1000 | 1500 | 2000 | 2500 | 3000 | 3500 |
| 1 | 15.1 | + | + | + | + | + | + |
| 2 | 30.2 | + | + | + | + | + | + |
| 4 | 60.5 | + | + | + | + | + | + |
| 6 | 90.7 | + | + | + | + | + | + |
| 8 | 121.0 | + | + | + | + | + | + |
| 10 | 151.2 | − | + | + | + | + | + |

During the training run, the motor speed and the BMEP are held constant for the time shown in the diagrams and corresponding values for the predicted quantities n_tc, P_T, P_R, P_C are determined, either by direct measurement or based on measurements by using model calculations. Parameters of the nominal models are adjusted such that the nominal models approximate the previously determined values for n_tc, P_T, P_R, P_C at the operating points. The adjustment of the parameters is also referred to as a learning or calibration process of the nominal model.

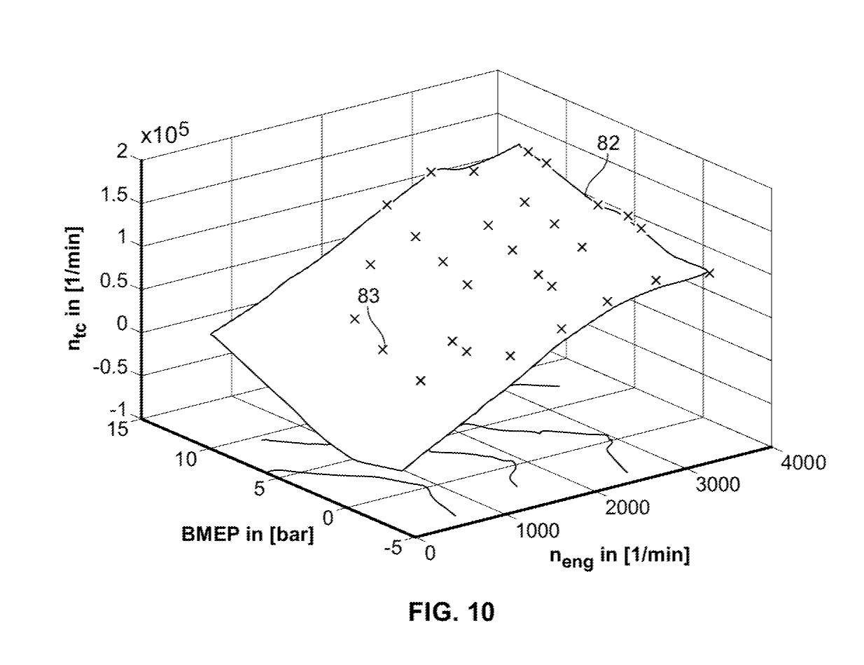

FIG. 10 shows a diagram for the nominal model of the turbocharger shaft speed, in which the parameters have been adjusted by the abovementioned calibration. In FIG. 10 the model output of the adjusted value for a given combination of BMEP and engine speed n_eng are indicated by a two dimensional surface 82. The two dimensional surface 82 may be realized as a lookup table in a computer readable memory. The determined values of n_tc at the operating point are indicated by crosses 83 which may lie above, on or below the surface 82. Level curves on the BMEP/engine speed plane illustrate the elevation profile of the two-dimensional plane. Similarly, the other nominal models for the energy conversion rates P_t, P_r, and P_c are also defined by two dimensional planes, which are determined by an approximation to values of P_t, P_r and P_c at predetermined operating points.

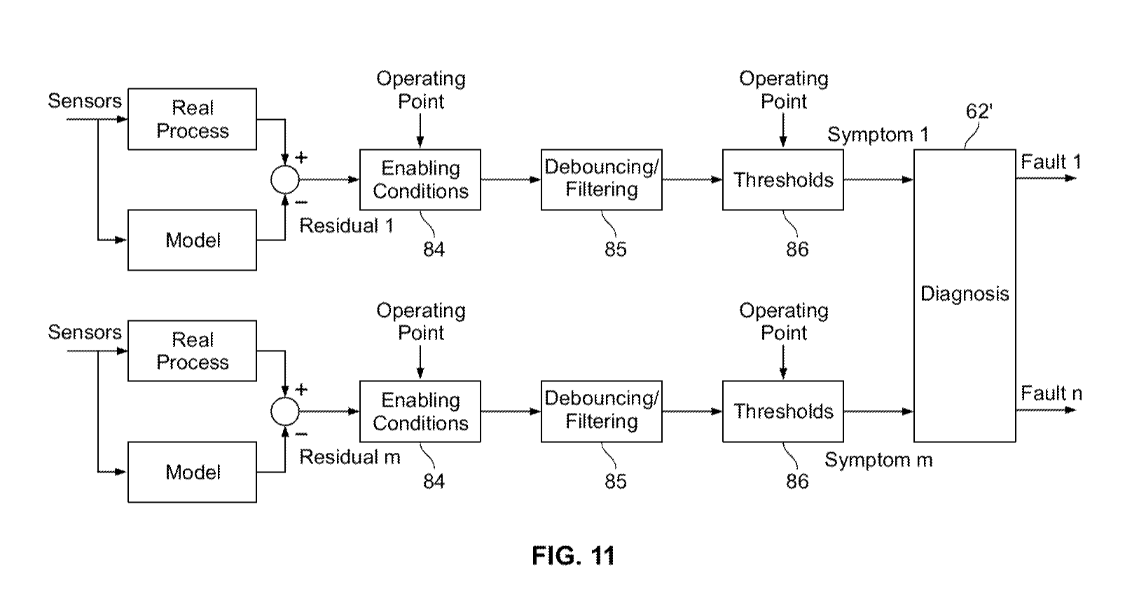

FIG. 11 shows a schematic flow diagram that further illustrates an evaluation of residuals according to the application. According to FIG. 11, m residuals are evaluated to generate n different fault conditions. In a residual generation step, the m residuals are generated by comparing output values from a model of the real process and from a nominal model. In a verification step, a verification unit 84 determines if an enabling condition is fulfilled, depending on an operating point. The operating point depends on input parameters of a nominal model, for example on the engine speed and on a fuel flow rate q_set. In a possible realization of the verification step, a residual is rejected as a valid input value for generating a fault condition if the flow rate q_set and the motor speed are not stable over a predetermined time or if the flow rate and the motor speed are not within a predetermined distance from an operating point.

In a compensation step, a compensation unit 85 smoothes outliers and other irregularities by filtering and compensates for spikes resulting from the operation of electrical switches by debouncing. In an evaluation step, an evaluation unit 86 compares the output of the compensation unit against a high threshold and a low threshold, depending on the value of the input parameters of the nominal models and on the operating point, and generates a corresponding symptom signal. In a diagnosis step, a diagnosis unit 62′ evaluates the m symptom signals of the evaluation units to generate an error signal which indicates, which of the n faults have occurred. The diagnosis unit 62′ may use inference logic, fuzzy logic or other methods which may be realized by lookup tables, for example.

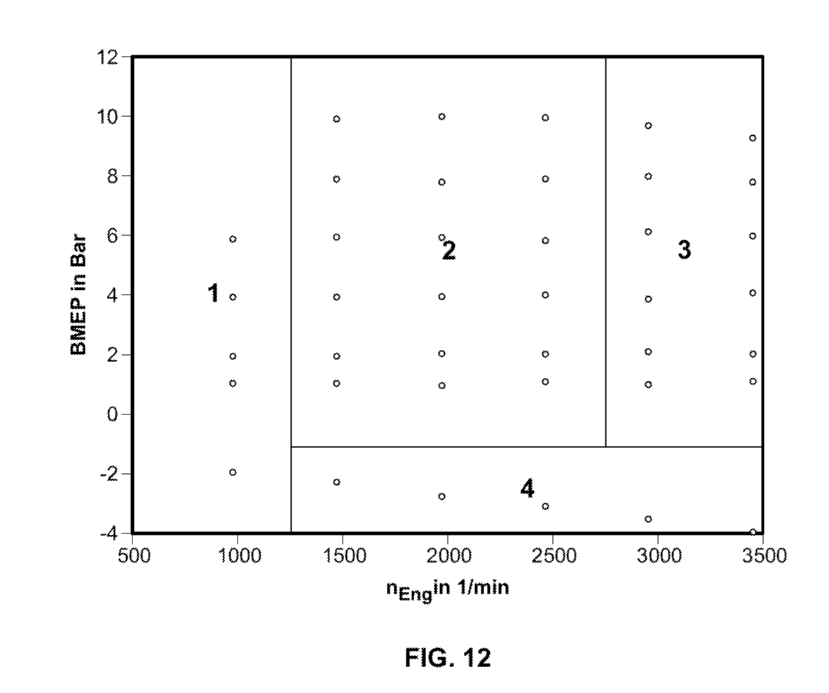

FIG. 12 shows, by way of example, a grouping of the parameter space of the input parameters of the nominal model into region according to the application. In this example, the parameter space is partitioned into 4 regions. To each of the four regions, a fault symptom table is associated. Operating points are indicated by circles. According to the application, a partitioning of the parameter space is defined through an iterative partitioning of parameter space using an LLM modeling procedure.

By way of example, four fault symptom tables are listed below. Herein, n_tc1 means the measured shaft revolution speed, n_tc2 the modeled shaft revolution speed and P_C, P_T, P_R the modeled energy conversion rates. Further, “−” means exceeding of the negative threshold, “+” means an exceeding of the positive threshold and 0 means a value within the thresholds with respect to the corresponding residual. “?” means that, in this parameter range the fault condition cannot be isolated from the 6 “symptoms” n_tc1, n_tc2, P_C, P_T and P_R. Where a table has two rows with identical values, further criteria must be applied to distinguish between the fault conditions, for example the time behavior of the residuals. Where a table comprises rows with only zeros, the fault condition cannot be found on basis of exceeding the thresholds and further criteria must be used as well.

TABLE 1
corresponding to the first parameter range:

| | n_tc1 | n_tc2 | P_C | P_T | P_R |
|---|---|---|---|---|---|
| blowby | 0 | − | 0 | 0 | 0 |
| EGR closed | 0 | + | 0 | 0 | 0 |
| leakage intake | 0 | − | 0 | 0 | 0 |
| leakage exhaust | − | + | 0 | 0 | − |
| restriction intake | 0 | 0 | 0 | 0 | 0 |
| VSA closed | 0 | 0 | 0 | 0 | 0 |

TABLE 2
corresponding to the second parameter range:

| | n_tc1 | n_tc2 | P_C | P_T | P_R |
|---|---|---|---|---|---|
| blowby | 0 | 0 | 0 | 0 | 0 |
| EGR closed | 0 | + | + | + | + |
| leakage intake | 0 | − | − | − | − |
| leakage exhaust | 0 | − | − | − | − |
| restriction intake | 0 | 0 | 0 | 0 | 0 |
| VSA closed | 0 | 0 | 0 | 0 | 0 |

TABLE 3
corresponding to the third parameter range:

| | n_tc1 | n_tc2 | P_C | P_T | P_R |
|---|---|---|---|---|---|
| blowby | 0 | 0 | 0 | 0 | 0 |
| EGR closed | − | + | + | + | + |
| leakage intake | 0 | − | − | − | − |
| leakage exhaust | − | − | − | − | − |
| restriction intake | − | + | + | + | + |
| VSA closed | 0 | 0 | + | + | 0 |

TABLE 4
corresponding to the fourth parameter range:

| | n_tc1 | n_tc2 | P_C | P_T | P_R |
|---|---|---|---|---|---|
| blowby | 0 | − | − | − | − |
| EGR closed | 0 | 0 | 0 | 0 | 0 |
| leakage intake | 0 | − | − | − | − |
| leakage exhaust | + | − | − | − | − |
| restriction intake | 0 | − | − | − | − |
| VSA closed | 0 | − | − | − | − |

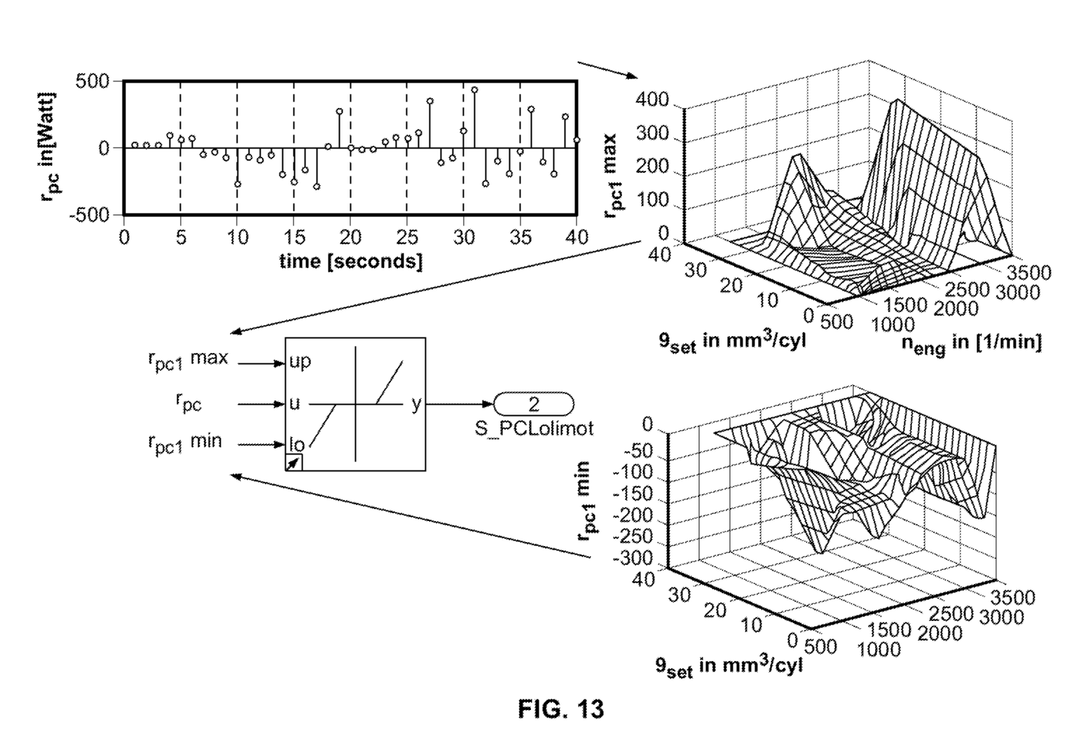

FIG. 13 illustrates a definition procedure for lower and upper thresholds of residuals. The upper left diagram shows a time behavior of the residual r_PC, relating to the compressor energy conversion rate. The time behavior of residuals at predefined operating points for known error conditions are used to define upper and lower thresholds, depending on the operating points. The diagrams on the right side show, respectively, lower and upper limits for r_PC depending on operating points. In this example, the operating points are defined by a grid on a two dimensional parameter space. The two dimensional parameter space is defined by a crankshaft revolution speed n_eng in revolutions per minute and a fuel throughput per cylinder, in cubic millimeters.

A dead zone element, which is shown inside the square symbol, sets the residual signal to zero if it is within the lower and upper threshold. If the residual signal lies outside the thresholds, the respective threshold is subtracted and the result is multiplied by a gain factor. The resulting signal, here denoted by S_PCLolimot is output for further evaluation.

Although the above description contains many specific details, these should not be construed as limiting the scope of the embodiments but merely providing illustration of the foreseeable embodiments. Especially, the above stated advantages of the embodiments should not be construed as limiting the scope of the embodiments but merely to explain possible achievements if the described embodiments are put into practice. These considerations also apply to the technical realization of the modeling units which may for example be realized as instructions of a computer readable program which in turn may be hardwired or stored in a computer readable memory, for example as instructions burned into an EPROM. Further realizations include lookup tables and interpolation of such lookup tables and hardwired embodiments of empirical models such as locally linear model trees (also known as LOLIMOT or LLM), neuronal networks and the like. The modeling units may correspond to hardware units but also to program modules or functions. Furthermore, in other embodiments one program module or hardware module may also correspond to several modeling units and vice versa.

Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A combustion engine evaluation unit, comprising:
a microprocessor configured to receiving measurement signals from a gas flow control system of a combustion engine and further configured to produce a state signal indicating a state of the gas flow control system;
first input ports of the microprocessor configured to receive a first set of measurement signals, the first set of measurement signals comprising:
a first pressure upstream of a turbocharger; and
a second pressure downstream of the turbocharger; and
second input ports of the microprocessor configured to receive a second set of measurement signals, the second set of measurement signals comprising a motor revolution speed,
wherein the microprocessor is further configured to:
calculate a first set of predicted values with a turbocharger model based on the first set of measurement signals;
calculate a second set of predicted values by using a nominal model, based on the second set of measurement signals; and
generate the state signal based on a comparison of the first set of predicted values with the second set of predicted values.

2. The combustion engine evaluation unit according to claim 1, further comprising third input ports of the microprocessor configured to receive an actual turbocharger shaft speed,
wherein the microprocessor is further configured to generate the state signal by including a second comparison of a predicted turbocharger shaft speed with the actual turbocharger shaft speed.

3. The combustion engine evaluation unit according to claim 1, wherein the first set of measurement signals further comprises:
a third pressure signal that corresponds to a third pressure downstream of a compressor of the turbocharger; and
a fourth pressure signal that corresponds to a fourth pressure between the compressor of the turbocharger and an exhaust turbine of the turbocharger.

4. The combustion engine evaluation unit according to claim 3, wherein the first set of measurement signals further comprises:
a first temperature signal that corresponds to a first temperature upstream of the compressor of the turbocharger; and
a second temperature signal that corresponds to a second temperature between the compressor of the turbocharger and the exhaust turbine of the turbocharger.

5. The combustion engine evaluation unit according to claim 1, wherein the second set of measurement signals further comprises a measurement signal for deriving a brake mean effective pressure of the combustion engine.

6. The combustion engine evaluation unit according to claim 3, wherein the turbocharger model comprises:
a compressor model;
a shaft model; and
an exhaust turbine model.

7. The combustion engine evaluation unit according to claim 6, wherein the compressor model, the shaft model, and the exhaust turbine model are configured to generate predicted energy conversion rates at the compressor, a shaft, and the exhaust turbine.

8. The combustion engine evaluation unit according to claim 6, wherein the shaft model is configured to generate a predicted shaft speed.

9. The combustion engine evaluation unit according to claim 1, further comprising a differentiator configured to compare the first set of predicted values with the second set of predicted values.

10. The combustion engine evaluation unit according to claim 1, further comprising a nominal model unit for the nominal model that comprises an interpolation unit.

11. An combustion engine evaluation unit comprising:
a microprocessor configured to receive measurement signals from a gas flow control system of a combustion engine and further configured to produce a state signal indicating a state of the gas flow control system;
first input ports of the microprocessor configured to receive a first set of measurement signals, the first set of measurement signals comprising:
a first pressure upstream of a turbocharger; and
a second pressure downstream of the turbocharger;
second input ports of the microprocessor configured to receive a second set of measurement signals, the second set of measurement signals comprising:
a first actuator signal for adjusting a variable turbine geometry; and
a second actuator signal for an exhaust gas recycling valve, wherein the microprocessor is configured to:
calculate a first set of predicted values by using a turbocharger model based on the first set of measurement signals;
calculate a second set of predicted values by using a nominal model based on the second set of measurement signals; and
generate the state signal based on a comparison of the first set of predicted values with the second set of predicted values.

12. The combustion engine evaluation unit according to claim 11, further comprising third input ports of the microprocessor configured to receive an actual turbocharger shaft speed,
wherein the microprocessor is further configured to generate the state signal by including a second comparison of a predicted turbocharger shaft speed with the actual turbocharger shaft speed.

13. The combustion engine evaluation unit according to claim 11, wherein the first set of measurement signals further comprises:
a third pressure signal that corresponds to a third pressure downstream of a compressor of the turbocharger; and
a fourth pressure signal that corresponds to a fourth pressure between the compressor of the turbocharger and an exhaust turbine of the turbocharger.

14. The combustion engine evaluation unit according to claim 13, wherein the first set of measurement signals further comprises:
a first temperature signal that corresponds to a first temperature upstream of the compressor of the turbocharger; and
a second temperature signal that corresponds to a second temperature between the compressor of the turbocharger and the exhaust turbine of the turbocharger.

15. The combustion engine evaluation unit according to claim 11, wherein the second set of measurement signals further comprises a measurement signal for deriving a brake mean effective pressure of the combustion engine.

16. The combustion engine evaluation unit according to claim 13, wherein the turbocharger model comprises:
a compressor model;
a shaft model; and
an exhaust turbine model.

17. The combustion engine evaluation unit according to claim 16, wherein the compressor model, the shaft model, and the exhaust turbine model are configured to generate predicted energy conversion rates at the compressor, a shaft, and the exhaust turbine.

18. The combustion engine evaluation unit according to claim 16, wherein the shaft model is configured to generate a predicted shaft speed.

19. The combustion engine evaluation unit according to claim 11, further comprising a differentiator configured to compare the first set of predicted values with the second set of predicted values.

20. The combustion engine evaluation unit according to claim 11, further comprising a nominal model unit for the nominal model that comprises an interpolation unit.
